(19) United States
(12) Patent Application Publication
(10) Pub. No.: US 2026/0285739 A1
(43) Pub. Date: Sep. 24, 2026

(54) INORGANIC COMPOSITION ARTICLE

(71) Applicant: OHARA INC., SAGAMIHARA-SHI, KANAGAWA (JP)

(72) Inventors: KOHEI OGASAWARA, SAGAMIHARA-SHI, KANAGAWA (JP); SAYA KIKKAWA, SAGAMIHARA-SHI, KANAGAWA (JP); TOSHITAKA YAGI, SAGAMIHARA-SHI, KANAGAWA (JP)

(21) Appl. No.: 19/475,428

(22) PCT Filed: Apr. 23, 2024
(86) PCT No.: PCT/JP2024/015902

§ 371 Date: Oct. 15, 2025

(30) Foreign Application Priority Data
Apr. 27, 2023 (JP) 2023-073209

(51) Int. Cl. C03C 10/00

(52) U.S. Cl. CPC C03C 10/0027

(57) ABSTRACT

An inorganic composition article comprising reinforced crystallized glass, wherein the crystallized glass comprises one or more selected from α-cristobalite and α-cristobalite solid solution as a main crystal phase, and the crystallized glass has, by mass % in terms of oxide, a content of a SiO₂ component being 50.0% to 75.0%, a content of a Li₂O component being 3.0% to 10.0%, a content of an Al₂O₃ component being 5.0% or more and less than 15.0%, a content of a B₂O₃ component being more than 0% and 10.0% or less, a content of a P₂O₅ component being more than 0% and 10.0% or less, and a mass proportion of SiO₂/(B₂O₃+Li₂O) is 3.0 to 10.0, and wherein the inorganic composition article has a compressive stress layer on a surface, and the inorganic composition article has a four-point bending strength of 760 MPa or higher.

### FIELD OF THE DISCLOSURE

The present disclosure relates to an inorganic composition article comprising reinforced crystallized glass with a compressive stress layer on a surface.

It is expected that various types of glasses will be used as a cover glass for protecting a display or a housing of portable electronic devices such as a smartphone and a tablet PC, and as a protector for protecting a lens of an in-vehicle optical device, an interior bezel, a console panel, a touch panel material, a smart key, and the like. These devices are required to be able to be used in harsh environments, and so there is an increasing demand for glass with higher strength.

Heretofore, a chemically reinforced glass has been used as a material for use in a protective member. However, the conventional chemically reinforced glass has been problematic because many accidents occur in which a portable device such as a smart phone is damaged when dropped. There is a need for crystallized glass with high strength and resistance to crack when dropped.

Glass with high strength tends to be less prone to cracking, but on the other hand, higher impact resistance when dropped may be required. A DOLzero (μm) of the thickness of the compressive stress layer and the compressive stress CS (MPa) contribute to the resistance to impact, so that glass with high strength, and desired DOLzero (μm) and compressive stress CS (MPa) is required.

Patent Document 1 discloses a material composition of a crystallized glass substrate for an information recording medium that can be chemically reinforced. Patent Document 1 states that an α-cristobalite-based crystallized glass described in Patent Document 1 may be chemically reinforced and may be utilized as a material substrate with high strength. However, crystallized glass for an information recording medium, which is represented by a substrate for a hard disk, is not intended for use in harsh environment.

Patent Document 2 discloses a microcrystalline glass product in which a main crystal phase having excellent mechanical properties contains lithium silicate and quartz crystal phases, but does not assume a strength capable of withstanding harsh environment.

### RELATED ART DOCUMENTS

### Patent Literatures

[Patent Document 1] JP 2008-254984 A
[Patent Document 2] JP 2021-520330 A

### SUMMARY OF THE DISCLOSURE

An object of the present disclosure is to provide an inorganic composition article comprising reinforced crystallized glass with high strength and desired DOLzero (μm) and compressive stress CS (MPa) that are hard to crack when dropped.

The present disclosure provides the following.

### (Configuration 1)

An inorganic composition article comprising reinforced crystallized glass, wherein
the crystallized glass comprises one or more selected from α-cristobalite and α-cristobalite solid solution as a main crystal phase, and
the crystallized glass has, by mass % in terms of oxide,
a content of a SiO₂ component being 50.0% to 75.0%,
a content of a Li₂O component being 3.0% to 10.0%,
a content of an Al₂O₃ component being 5.0% or more and less than 15.0%,
a content of a B₂O₃ component being more than 0% and 10.0% or less,
a content of a P₂O₅ component being more than 0% and 10.0% or less, and
a mass proportion of SiO₂/(B₂O₃+Li₂O) is 3.0 to 10.0, and
wherein the inorganic composition article has a compressive stress layer on a surface, and
the inorganic composition article has a four-point bending strength of 760 MPa or higher.

### (Configuration 2)

The inorganic composition article according to Configuration 1,
wherein the crystallized glass has, by mass % in terms of oxide,
a content of a ZrO₂ component being more than 0% and 10.0% or less, and
a total content of the Al₂O₃ component and the ZrO₂ component being 10.0% or more.

### (Configuration 3)

The inorganic composition article according to Configuration 1 or 2, wherein
the crystallized glass has, by mass % in terms of oxide,
a content of a K₂O component being 0% to 5.0%.

### (Configuration 4)

The inorganic composition article according to any one of Configurations 1 to 3, wherein
the crystallized glass has, by mass % in terms of oxide,
a content of a Na₂O component being 0% to 4.0%.
a content of a MgO component being 0% to 4.0%,
a content of a CaO component being 0% to 4.0%,
a content of a SrO component being 0% to 4.0%,
a content of a BaO component being 0% to 5.0%,
a content of a ZnO component being 0% to 10.0%, and
a content of a Sb₂O₃ component being 0% to 3.0%.

### (Configuration 5)

The inorganic composition article according to any one of Configurations 1 to 4, wherein
the crystallized glass has, by mass % in terms of oxide,
a content of a Nb₂O₅ component being 0% to 5.0%,
a content of a Ta₂O₅ component being 0% to 6.0%, and
a content of a TiO₂ component being 0% or more and less than 1.0%.

### (Configuration 6)

The inorganic composition article according to any one of Configurations 1 to 5, wherein a glass transition temperature Tg of glass before crystallization of the crystallized glass is 610° C. or lower.

### (Configuration 7)

The inorganic composition article according to any one of Configurations 1 to 6, wherein [compressive stress CS (MPa)]×[thickness of the compressive stress layer DOLzero (μm)]/[substrate thickness t (mm)] is 100 to 350.

According to the present disclosure, by managing the amount of LiO₂ and adjusting the amount of SiO₂ and the amount of Al₂O₃, an inorganic composition article including crystallized glass with high impact resistance can be easily produced and stably produced. In addition, it is possible to provide an inorganic composition article with high strength and desired DOLzero (μm) and compressive stress CS (MPa).

The “inorganic composition article” of the present disclosure (hereinafter, it may be simply referred to as “the article”) is composed of an inorganic composition material such as glass, crystallized glass, ceramics, or a complex material thereof. The article of the present disclosure includes, for example, an article obtained by processing these inorganic materials or synthesizing from these inorganic materials through chemical reaction to form into a desired shape. A green compact obtained by pulverizing the inorganic materials followed by pressurization, and a sintered body obtained by sintering the green compact, for example, are also included. Here, the shape of the article obtained is not limited in smoothness, curvature, size, and the like. Examples of the shape of the article include a plate-shaped substrate, a formed body having a curvature, and a three-dimensional structure having a complicated shape. Chemically reinforced inorganic composition material is also included.

The inorganic composition article of the present disclosure can be used for a protective member of a device by taking advantage of being a glass based material with high strength. The inorganic composition article of the present disclosure may be utilized as a cover glass or a housing of a smartphone, a member of a portable electronic device such as a tablet PC and a wearable terminal, and a protective protector, a member of a substrate for a head-up display, or the like used in a transport vehicle such as a car and an airplane. The inorganic composition article according to the present disclosure can also be used for other electronic devices and machinery, a building member, a member for a solar panel, a member for a projector, a cover glass (windshield) for eyeglasses and watches, and the like.

### DETAILED DESCRIPTION OF THE EXEMPLARY EMBODIMENTS

Hereinafter, embodiments and examples of the inorganic composition article of the present disclosure will be described in detail. However, the present disclosure is not limited to the following embodiments and examples, and can be appropriately modified within the scope of an object of the present disclosure.

The inorganic composition article in the present disclosure and crystallized glass as a base material thereof contains one or more selected from α-cristobalite and α-cristobalite solid solution as a main crystal phase. The crystallized glass that precipitates these crystal phases has high mechanical strength.

Here, the term “main crystal phase” in the present specification corresponds to a crystal phase contained in the largest amount in the crystallized glass, as determined based on a peak of an X-ray diffraction pattern.

In the present specification, contents of each component are all expressed by mass % in terms of oxide unless otherwise specified. Here, “in terms of oxide” means, when it is assumed that all components constituting the crystallized glass are decomposed and converted into oxides thereof, and a total mass of the oxides is 100 mass %, an amount of each oxide of the components contained in the crystallized glass is expressed by mass %. In the present specification, “A % to B %” represents A % or more and B % or less.

Hereinafter, an inorganic composition article according to a first embodiment of the present disclosure will be described.

Reinforced crystallized glass of the inorganic composition article according to the first embodiment of the present disclosure and crystallized glass as a base material thereof has, by mass % in terms of oxide,
a content of a SiO₂ component being 50.0% to 75.0%,
a content of a Li₂O component being 3.0% to 10.0%,
a content of an Al₂O₃ component being 5.0% or more and less than 15.0%,
a content of a B₂O₃ component being more than 0% and 10.0% or less,
a content of a P₂O₅ component being more than 0% and 10.0% or less, and
a mass proportion of SiO₂/(B₂O₃+Li₂O) being 3.0 to 10.0.

The above composition allows for reinforcing by chemical reinforcing, providing a reinforced crystallized glass with high strength and desired DOLzero (μm) and compressive stress CS (MPa).

Hereinafter, specifically, the composition range each of the components constituting the crystallized glass as a base material of the present disclosure is specifically explained.

The SiO₂ component is an essential component necessary for constituting one or more selected from α-cristobalite and α-cristobalite solid solution. When the content of the SiO₂ component is 75.0% or less, excessive increase in viscosity and deterioration in meltability can be suppressed, and when the content is 50.0% or more, deterioration in devitrification can be suppressed.

Preferably, an upper limit of the content of the SiO₂ component is 74.0% or less, 73.0% or less, 72.0% or less, or 70.0% or less. Preferably, a lower limit of the content of the SiO₂ component is 55.0% or more, 58.0% or more, or 60.0% or more.

The Li₂O component is a component that increases the meltability of the raw glass, and when the content thereof is 3.0% or more, the meltability of the raw glass can be increased, and when the content thereof is 10.0% or less, it is possible to suppress an increase in the production of lithium disilicate crystals. The Li₂O component is also a component involved in chemical reinforcing for a crystallized glass.

Preferably, a lower limit of the content of the Li₂O component is 3.5% or more, 4.0% or more, 4.5% or more, 5.0% or more, or 5.5% or more. Preferably, an upper limit of the content of the Li₂O component is 9.0% or less, for example, may be 8.5% or less, or 8.0% or less.

The Al₂O₃ component is a component suitable for increasing the mechanical strength of a crystallized glass. When the content of the Al₂O₃ component is less than 15.0%, deterioration in solubility and devitrification can be suppressed, and when the content is 5.0% or more, reduction in mechanical strength can be suppressed.

Preferably, an upper limit of the content of the Al₂O₃ component is 14.5% or less, 14.0% or less, 13.5% or less, or 13.0% or less. Preferably, a lower limit of the content of the Al₂O₃ component is 5.5% or more, 5.8% or more, 6.0% or more, 6.5% or more, or 8.0% or more.

The B₂O₃ component is a component suitable for lowering glass transition temperature of a crystallized glass, and when the content of the B₂O₃ component is 10.0% or less, reduction in chemical durability can be suppressed.

Preferably, an upper limit of the content of the B₂O₃ component is 8.0% or less, 7.0% or less, 5.0% or less, or 4.0% or less. A lower limit of the content of the B₂O₃ component is more than 0%, and preferably 0.001% or more, 0.01% or more, 0.05% or more, 0.10% or more, or 0.30% or more.

A ZrO₂ component is a component capable of increasing the mechanical strength of a crystallized glass, and when the content of the ZrO₂ component is 10.0% or less, deterioration of the meltability can be suppressed.

Preferably, an upper limit of the content of the ZrO₂ component is 10.0% or less, 9.0% or less, 8.5% or less, or 8.0% or less. Preferably, the lower limit of the content of the ZrO₂ component is more than 0%, 1.0% or more, 1.5% or more, or 2.0% or more.

When the sum of the contents of the Al2O3 component and the ZrO₂ component, that is [Al₂O₃+ZrO₂], is large, the compressive stress of a surface of a crystallized glass increases when the reinforcing is performed therefor. Preferably, a lower limit of [Al₂O₃+ZrO₂] is 10.0% or more, 11.0% or more, 12.0% or more, or 13.0% or more.

On the other hand, when [Al₂O₃+ZrO₂] is 22.0% or less, deterioration in the meltability can be suppressed. Therefore, an upper limit of [Al₂O₃+ZrO₂] is preferably 22.0% or less, 21.0% or less, 20.0% or less, or 19.0% or less.

The mass proportion of SiO₂/(B₂O₃+Li₂O) is from 3.0 to 10.0. When this mass proportion is 3.0 to 10.0, it is possible to contribute to make the viscosity of glass to be low. By this, glass preparation is made to be easier, as well as the quantity of alkaline ions ion-exchanged during chemical reinforcing increases, and a reinforced crystallized glass having a desired CS30 (compressive stress at a depth of 30 μm from the outermost surface) can be produced.

Therefore, a lower limit of the mass proportion of SiO₂/(B₂O₃+Li₂O) is preferably 3.5 or more, and more preferably 4.64 or more. An upper limit of the mass proportion of SiO₂/(B₂O₃+Li₂O) is preferably 9.5 or less, and more preferably less than 8.6.

When the sum of the contents of the SiO₂ component, the Li₂O component, the Al₂O₃ component, and the B₂O₃ component, that is [SiO₂+Li₂O+Al₂O₃+B₂O₃], is large, glass which is easy to be chemically reinforced and has high strength can be obtained. Therefore, a lower limit of [SiO₂+Li₂O+Al₂O₃+B₂O₃] is preferably 75.0% or more, 77.0% or more, 79.0% or more, 80.0% or more, 83.0% or more, or 85.0% or more. An upper limit of [SiO₂+Li₂O+Al₂O₃+B₂O₃] is not particularly limited, but may be, for example, less than 100%, or 99% or less.

The P₂O₅ component is an essential component that can be added to let act as a crystal nucleating agent for the glass. When the content of the P₂O₅ component is 10.0% or less, deterioration of devitrification of glass and phase separation of glass can be suppressed.

An upper limit of the content of the P₂O₅ component is preferably 8.0% or less, 6.0% or less, 5.0% or less, or 4.0% or less. A lower limit of the content of the P₂O₅ component is more than 0%, for example, 0.5% or more, 1.0% or more, or 1.5% or more.

A K₂O component is an optional component that participates in chemical reinforcing when the content thereof is more than 0%. A lower limit of the content of the K₂O component may be 0% or more, more than 0%, 0.1% or more, 0.3% or more, or 0.5% or more.

Further, when the content of the K₂O component is 5.0% or less, it is possible to promote the precipitation of crystals. Therefore, an upper limit of the content of the K₂O component may be preferably 5.0% or less, 4.0% or less, 3.5% or less, or 3.0% or less.

A Na₂O component is an optional component that participates in chemical reinforcing when the content thereof is more than 0%. When the content of the Na₂O component is 4.0% or less, a desired crystal phase can be easily obtained. An upper limit of the content of the Na₂O component may be preferably 4.0% or less, 3.5% or less, more preferably 3.0% or less, and still more preferably 2.5% or less. A lower limit of the content of the Na₂O component may be 0% or more.

A MgO component, a CaO component, a SrO component, a BaO component, and a ZnO component are optional components that increase the low-temperature meltability when each content thereof is more than 0%, and may be contained within a range that does not impair the effects of the present disclosure.

Therefore, an upper limit of the content of the MgO component may be preferably 4.0% or less, 3.5% or less, 3.0% or less, or 2.5% or less. Preferably, a lower limit of the content of the MgO component may be 0% or more, more than 0%, 0.3% or more, or 0.4% or more.

Preferably, an upper limit of the content of the CaO component may be 4.0% or less, 3.0% or less, 2.5% or less, or 2.0% or less. A lower limit of the content of the CaO component may be 0% or more.

Preferably, an upper limit of the content of the SrO component may be 4.0% or less, 3.0% or less, 2.5% or less, or 2.0% or less. A lower limit of the content of the SrO component may be 0% or more.

Preferably, an upper limit of the content of the BaO component may be 5.0% or less, 4.0% or less, 3.0% or less, 2.5% or less, or 2.0% or less. A lower limit of the content of the BaO component may be 0% or more.

Preferably, an upper limit of the content of the ZnO component may be 10.0% or less, 9.0% or less, 8.5% or less, 8.0% or less, or 7.5% or less. Preferably, a lower limit of the content of the ZnO component may be 0% or more, more than 0%, 0.5% or more, or 1.0% or more.

The crystallized glass may or may not contain a Nb₂O₅ component, a Ta₂O₅ component, and a TiO₂ component, respectively, within a range that does not impair the effects of the present disclosure.

The Nb₂O₅ component is an optional component that increases the mechanical strength of a crystallized glass when the content thereof is more than 0%. Preferably, an upper limit of the content of the Nb₂O₅ component may be 5.0% or less, 4.0% or less, 3.5% or less, or 3.0% or less. A lower limit of the content of the Nb₂O₅ component may be 0% or more.

The Ta₂O₅ component is an optional component that increases the mechanical strength of a crystallized glass when the content thereof is more than 0%. Preferably, a upper limit of the content of the Ta₂O₅ component may be 6.0% or less, 5.5% or less, 5.0% or less, or 4.0% or less. A lower limit of the content of the Ta₂O₅ component may be 0% or more.

The TiO₂ component is an optional component that increases the chemical durability of a crystallized glass when the content thereof is more than 0%. Preferably, an upper limit of the content of the TiO₂ component may be less than 1.0%, 0.8% or less, 0.5% or less, or 0.1% or less. A lower limit of the content of the TiO₂ component may be 0% or more.

The crystallized glass may or may not contain a La₂O₃ component, a Gd₂O₃ component, an Y₂O₃ component, a WO₃ component, a TeO₂ component, and a Bi₂O₃ component, respectively, within a range that does not impair the effects of the present disclosure. The blending amount of each of these components may be 0% to 2.0%, 0% or more and less than 2.0%, or 0% to 1.0%.

The crystallized glass may or may not contain other components not described above, within a range that does not impair the effects of the present disclosure. Examples of the other components include metal components such as Yb, Lu, V, Cr, Mn, Fe, Co, Ni, Cu, Ag, and Mo (including metal oxides thereof).

An Sb₂O₃ component may be contained as a glass clarifying agent. On the other hand, when the content of the Sb₂O₃ component is 3.0% or less, it is possible to suppress decrease in transmittance in the short-wavelength range of the visible-light range. Therefore, an upper limit of the content of the Sb₂O₃ component is preferably 3.0% or less, more preferably 2.0% or less, still more preferably 1.0% or less, and yet still more preferably 0.6% or less. A lower limit of the content of the Sb₂O₃ component may be 0% or more.

As the glass clarifying agent, one or two or more selected from the group consisting of a SnO₂ component, a CeO₂ component, an As₂O₃ component, F, NOx, and SOx may or may not be contained in addition to the Sb₂O₃ component. It is noted that an upper limit of the content of the clarifying agent may be preferably 2.0% or less, more preferably 1.0% or less, and most preferably 0.6% or less.

On the other hand, there is a tendency to refrain from using each component of Pb, Th, Tl, O₅, Be, Cl, and Se, which are considered in recent years as harmful chemical substances, and thus, it is preferable that these components are substantially not contained.

The compressive stress CS (MPa) of the compressive stress layer of the inorganic composition article is preferably 550 MPa or higher, more preferably 600 MPa or higher, and still more preferably 700 MPa or higher. For example, an upper limit of compressive stress CS is 1400 MPa or lower, 1300 MPa or lower, 1200 MPa or lower, or 1100 MPa or lower. When the compressive stress layer has such a compressive stress value, it is possible to suppress the growth of cracks and increase the mechanical strength of the crystallized glass.

The compressive stress CS (MPa) can be measured by the method described in Examples.

The central tensile stress CT (MPa) is an index of the degree of reinforcing of glass by chemical reinforcing. When the value of CT is high, the pieces caused at breaking the glass are small and the glass tends to be smashed into smithereens. Therefore, in order to obtain the impact resistance of glass, a lower limit of the central tensile stress CT (MPa) is 70 MPa or higher, preferably 75 MPa or higher, more preferably 80 MPa or higher, and even more preferably 85 MPa or higher. An upper limit of central tensile stress CT (MPa) is 200 MPa or lower, preferably 150 MPa or lower, more preferably 120 MPa or lower. By chemical reinforcing, it is possible to obtain a desired strengthened glass-ceramic having a central tensile stress in such a range.

The central tensile stress CT (MPa) can be measured by the method described in Examples.

The thickness of the compressive stress layer DOLzero (μm) varies depending upon the thickness of the inorganic composition article, and may be 8.0 μm to 500 μm. More preferably the thickness DOLzero may be 9.5 μm to 440 μm, more preferably 20 μm to 400 μm, still more preferably 30 μm to 350 μm, yet still more preferably 50 μm to 300 μm, and even more preferably from 60 μm to 120 μm. For example, when the plate thickness of the inorganic composition article is 0.1 mm, DOLzero may be 8.0 μm to 25 μm. An upper limit of DOLzero when the plate thickness of the inorganic composition article is 0.1 mm may be, for example, 25 μm or smaller, 22 μm or smaller, or 20 μm or smaller. A lower limit of DOLzero when the plate thickness of the inorganic composition article is 0.1 mm may be, for example, 8.0 μm or larger, 8.5 μm or larger, or 9.5 μm or larger. When the plate thickness of the inorganic composition article is 2.0 mm, DOLzero may be 160 to 500 μm. An upper limit of DOLzero when the plate thickness of the inorganic composition article is 2.0 mm may be, for example, 500 μm or smaller, 440 μm or smaller, or 400 μm or smaller. A lower limit of DOLzero when the plate thickness of the inorganic composition article is 2.0 mm may be, for example, 160 μm or larger and 180 μm or larger.

An lower limit of the thickness DOLzero of the compressive stress layer is 8.0% or more, preferably 9.0% or more, more preferably 9.5% or more, more preferably 10% or more, and still more preferably 15% or more, of the plate thickness of the inorganic composition article. An upper limit of the thickness DOLzero of the compressive stress layer is 25.0% or less, preferably 22.0% or less, and more preferably 20.0% or less, of the plate thickness of the inorganic composition article.

The thickness DOLzero (μm) of the compressive stress layer can be measured by the method described in Examples.

When the crystallized glass as an inorganic composition article is used as a substrate, a lower limit of the thickness of the substrate (plate thickness) is preferably 0.1 mm or larger, more preferably 0.3 mm or larger, more preferably 0.4 mm or larger, and more preferably 0.5 mm or larger, and an upper limit of the thickness of the substrate is preferably 2.0 mm or smaller, more preferably 1.5 mm or smaller, more preferably 1.1 mm or smaller, more preferably 1.0 mm or smaller, more preferably 0.9 mm or smaller, and more preferably 0.8 mm or smaller.

Here, the “plate thickness of the inorganic composition article” refers to a distance between two main surfaces that are arranged approximately parallel and face each other when the shape of the inorganic composition article is a plate shape having a finite thickness. For example, when the shape of the inorganic composition article is a strip shape having a finite thickness, the plate thickness of the strip-shaped inorganic composition article refers to the distance between two approximately rectangular planes.

$$[ Compressive stress CS ( MPa ) ] \times [ thickness of compressive stress layer DOLzero ( μ m ) ] / [ substrate thickness t ( mm ) ] is an index of impact resistance .$$

That is, a lower limit of [compressive stress CS (MPa)]×[thickness of compressive stress layer DOLzero (μm)]/[substrate thickness t (mm)] of crystallized glass of the present disclosure is preferably 100 or more, more preferably 110 or more, and still more preferably 120 or more.

On the other hand, an upper limit of [compressive stress CS (MPa)]×[thickness of compressive stress layer DOLzero (μm)]/[substrate thickness t (mm)] is preferably 350 or less, more preferably 300 or less, and still more preferably 250 or less. To have such a numerical range, the crystallized glass with high strength can be obtained by chemical reinforcing.

The four-point bending strength (bending stress) of the inorganic composition article is 760 MPa or higher, and may be 800 MPa or higher, 850 MPa or higher, 900 MPa or higher, 950 MPa or higher, 1000 MPa or higher, 1050 MPa or higher, 1100 MPa or higher, 1150 MPa or higher, or 1200 MPa or higher. By having such a four-point bending strength, the inorganic composition article according to one embodiment of the present disclosure has high strength against deformation and is less likely to crack.

The four-point bending strength is measured by the method described in Examples.

The crystallized glass of the inorganic composition article according to embodiments of the present disclosure (hereinafter, simply referred to as “crystallized glass”) may be manufactured by the following method. That is, raw materials are uniformly mixed so that each of the components satisfies a predetermined content range, followed by subjecting it to melt-molding to produce raw glass. Next, the raw glass is crystallized to manufacture crystallized glass.

The glass transition temperature Tg of glass before crystallization of the crystallized glass is preferably 610° C. or lower, more preferably 600° C. or lower, and even more preferably 590° C. or lower.

Heat treatment for precipitating crystals may be carried out at one-staged temperature or at two-staged temperatures.

In the heat treatment at two-staged temperatures, firstly, heat treatment is carried out at a first temperature so as to do a nucleation step, and then heat treatment is carried out at a second temperature higher than the temperature used in the nucleation step so as to do crystal growth step.

The first temperature in the two-staged heat treatment may preferably be 450° C. to 750° C., more preferably 500° C. to 720° C., and still more preferably 550° C. to 680° C. A retention time at the first temperature is preferably 30 minutes to 2000 minutes, and more preferably 180 minutes to 1440 minutes.

The second temperature in the two-staged heat treatment may be preferably 550° C. to 850° C., and more preferably 600° C. to 800° C. A retention time at the second temperature is preferably 30 minutes to 600 minutes, and more preferably 60 minutes to 400 minutes.

In the one-staged heat treatment, the nucleation step and the crystal growth step are continuously performed at the one-staged temperature. Typically, heat treatment temperature is increased up to a predetermined temperature, is maintained for a certain period of time after reaching the predetermined temperature, and is then lowered.

In the one-staged heat treatment, the heat treatment temperature is preferably 600° C. to 800° C., and more preferably 630° C. to 770° C. A retention time at the heat treatment temperature is preferably 30 minutes to 500 minutes, and more preferably 60 minutes to 400 minutes.

In the inorganic composition article, as one example of the method for forming a compressive stress layer, a chemical reinforcing method can be mentioned, in which an alkali component present in a surface layer of crystallized glass is subject to an exchange reaction with an alkali component having an ionic radius larger than the former alkali component to form a compressive stress layer on the surface layer. As other examples thereof, a heat reinforcing method in which crystallized glass is heated and subsequently rapidly cooled, and an ion implantation method in which ions are implanted into the surface layer of crystallized glass, can be mentioned.

In the inorganic composition article of the present disclosure may be produced, for example, by the following chemical reinforcing method.

A crystallized glass is contacted with or immersed in a molten salt of a salt containing potassium, sodium and lithium, for example, a mixed salt or a complex salt of potassium nitrate (KNO₃), sodium nitrate (NaNO₃), and lithium nitrate (LiNO₃). The treatment in which the crystallized glass is contacted with or immersed in the molten salt may be performed in one stage or in two stages.

In the case of two-staged chemical reinforcing treatment, for example, firstly, crystallized glass is contacted with or immersed in a mixed salt of potassium and sodium, a sodium salt, or a mixed salt of potassium, sodium and lithium, heated at 350° C. to 550° C. for 1 to 1440 minutes, preferably 15 to 500 minutes, more preferably 30 to 300 minutes. Subsequently, secondly, the resultant crystallized glass is contacted with or immersed in a potassium salt, a mixed salt of potassium and sodium, a mixed salt of potassium and lithium, or a mixed salt of potassium, sodium and lithium, heated at 350° C. to 550° C. for 1 to 1440 minutes, preferably 60 to 600 minutes.

In the case of two-staged chemical reinforcing treatment, for example, it is desirable that in the first stage treatment, a single bath of potassium (KNO₃), sodium (NaNO₃) or lithium (LiNO₃), or a mixed bath thereof is used, and in the second stage treatment, a molten salt of a mixed salt or a complex salt of a salt containing potassium, sodium, and lithium, for example, potassium nitrate (KNO₃), sodium nitrate (NaNO₃), and lithium nitrate (LiNO₃).

In the case of one-staged chemical reinforcing treatment, for example, crystallized glass is contacted with or immersed in a mixed salt containing potassium and sodium, a mixed salt containing potassium, sodium, and lithium, a mixed salt containing sodium, and a mixed salt containing sodium and lithium (a mixed salt containing potassium and/or sodium and/or lithium), heated at 350° C. to 550° C. for 1 to 1440 minutes, preferably 30 to 500 minutes.

### EXAMPLES

### Examples 1 to 27, and Comparative Example 1

### 1. Production of Inorganic Composition Article

As raw materials, oxides, hydroxides, carbonates, nitrates, fluorides, chlorides, or metaphosphate compounds corresponding to each of the components of crystallized glass were selected, and the selected raw materials were each weighed so as to be a composition described in Tables 1 to 4, respectively, and uniformly mixed.

Next, the mixed raw materials were placed in a platinum crucible and melted in an electric furnace at 1300° C. to 1600° C. for 2 to 24 hours. Thereafter, the molten glass was homogenized with stirring, then cooled to 1000° C. to 1450° C., cast into a mold, and slowly cooled to prepare raw glass. The obtained raw glass was respectively heated under crystallization conditions of a nucleation step and a crystallization step described in Tables 1 to 4 to prepare crystallized glass.

The crystal phase of the crystallized glass was determined from an angle of a peak appearing in an X-ray diffraction pattern obtained by using an X-ray diffraction analyzer (“D8 Discover” manufactured by Bruker). When the X-ray diffraction patterns of the crystallized glasses of Examples 1 to 27 were observed, it was determined that the α-cristobalite and/or α-cristobalite solid solution precipitated as the main crystal phase, based on the fact that peaks were observed at positions corresponding to the peak pattern of the α-cristobalite and/or α-cristobalite solid solution. Further, when the X-ray diffraction pattern of the crystallized glass of Comparative Example 1 was observed, it was determined that Liz₂Si₂O₅ and α-quartz were the main crystal phases, based on the fact that no peak of α-cristobalite was observed and peaks were observed at positions corresponding to the peak patterns of Li₂Si₂O₅ and α-quartz.

The glass transition temperatures (Tg) of glass before crystallization of the crystallized glass produced in each of Examples 1 to 27 and Comparative Example 1 were measured in accordance with the Japanese Optical Glass Industry Standard JOGIS08-2019 “Measuring Methods for Thermal Expansion of Optical Glass”.

Tg's of Example 16 and Comparative Example 1 were not measurable.

The crystallized glasses prepared in Example 1 and Comparative Example 1 were each cut and ground, and further subjected to parallel polishing the opposing sides of the cut crystallized glass so that the plate thickness was made to be ones each described in Tables 5 to 9, to obtain crystallized glass substrates. The crystallized glass substrates were used as a base material to obtain respective chemically reinforced crystallization glass substrates of Examples 1-1 to 1-29 and Comparative Example 1-1.

In Examples 1-1 to 1-29, the crystallized glass produced in Example 1 was used, and subjected to chemical reinforcing treatment under the reinforcing conditions shown in Tables 5 to 9. The crystallized glass used was one having a width of 72 mm, a length of 135 mm, and a thickness polished to be each described in Tables 5 to 9.

In Comparative Example 1-1, the crystallized glass produced in Comparative Example 1 is used, and subjected to a chemical reinforcing treatment under the reinforcing conditions shown in Table 9.

For example, in Examples 1-1 in Table 5 (first stage of reinforcing conditions), “KNO₃ 10:NaNO₃ 1, 450° C.×120 min” indicates that immersion was carried out in a mixed bath of potassium salt and sodium salt at a ratio of 10:1 by mass, at 450° C. for 120 minutes.

Also, for example, in Examples 1-2 of Table 5 (second stage of chemical reinforcing), “KNO₃, 400° C.×300 min” indicates that immersion was carried out in a single bath of a potassium salt, at 400° C. for 300 minutes.

TABLE 1

| Examples | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|
| Composition | SiO₂ | | 64.81 | 64.36 | 64.86 | 64.20 | 64.86 | 64.20 | 64.86 | 64.86 |
| [mass %] | Al₂O₃ | | 12.72 | 12.44 | 12.44 | 12.10 | 12.44 | 12.40 | 12.44 | 12.64 |
| | B₂O₃ | | 2.00 | 0.50 | 1.00 | 0.50 | 1.00 | 1.00 | 1.00 | 1.00 |
| | P₂O₅ | | 2.14 | 2.04 | 2.04 | 2.60 | 2.04 | 2.60 | 2.04 | 2.04 |
| | Li₂O | | 7.13 | 7.14 | 7.14 | 6.97 | 7.14 | 6.97 | 7.14 | 7.14 |
| | Na₂O | | 0.50 | | | | | | | |
| | K₂O | | 0.73 | 1.53 | 1.53 | 1.50 | 1.53 | 1.50 | 1.53 | 1.33 |
| | MgO | | 1.02 | 1.02 | 1.02 | 1.70 | 2.02 | 0.60 | 0.52 | 1.02 |
| | CaO | | 0.41 | 0.41 | 0.41 | 0.65 | 0.41 | 0.55 | 0.91 | 0.41 |
| | SrO | | | | | | | | | |
| | BaO | | | | | | | | | |
| | ZnO | | 2.88 | 4.88 | 3.88 | 4.10 | 2.88 | 4.50 | 3.88 | 3.88 |
| | ZrO₂ | | 5.60 | 5.60 | 5.60 | 5.60 | 5.60 | 5.60 | 5.60 | 5.60 |
| | Nb₂O₅ | | | | | | | | | |
| | Ta₂O₅ | | | | | | | | | |
| | TiO₂ | | | | | | | | | |
| | Sb₂O₃ | | 0.06 | 0.08 | 0.08 | 0.08 | 0.08 | 0.08 | 0.08 | 0.08 |
| | Total | | 100.00 | 100.00 | 100.00 | 100.00 | 100.00 | 100.00 | 100.00 | 100.00 |
| | SiO₂ + Li₂O + Al₂O₃ + B₂O₃ | | 86.66 | 84.44 | 85.44 | 83.77 | 85.44 | 84.57 | 85.44 | 85.64 |
| | SiO₂/(B₂O₃ + Li₂O) | | 7.10 | 8.42 | 7.97 | 8.59 | 7.97 | 8.06 | 7.97 | 7.97 |
| | Al₂O₃ + ZrO₂ | | 18.32 | 18.04 | 18.04 | 17.70 | 18.04 | 18.00 | 18.04 | 18.24 |
| Crystallization | Nucleation | Temperature [° C.] | 600 | 600 | 600 | 600 | 600 | 600 | 600 | 600 |
| Conditions | | Retention time [h] | 5 | 5 | 5 | 5 | 5 | 5 | 5 | 5 |
| | Crystal | Temperature [° C.] | 660 | 700 | 680 | 660 | 660 | 700 | 660 | 660 |
| | growth | Retention time [h] | 5 | 5 | 5 | 5 | 5 | 5 | 5 | 5 |

| | | | | | | | | |
|---|---|---|---|---|---|---|---|---|
| Tg [° C.] | 579 | 600 | 589 | 592 | 577 | 595 | 592 | 593 |

TABLE 2

| Examples | | | Ex. 9 | Ex. 10 | Ex. 11 | Ex. 12 | Ex. 13 | Ex. 14 | Ex. 15 | Ex. 16 |
|---|---|---|---|---|---|---|---|---|---|---|
| Composition | SiO₂ | | 64.86 | 64.86 | 64.86 | 64.86 | 64.86 | 64.86 | 60.00 | 71.42 |
| [mass %] | Al₂O₃ | | 12.44 | 12.44 | 12.44 | 12.74 | 12.44 | 12.44 | 12.10 | 5.70 |
| | B₂O₃ | | 2.00 | 3.00 | 2.00 | 2.00 | 2.00 | 2.00 | 3.00 | 2.00 |
| | P₂O₅ | | 2.04 | 2.04 | 2.04 | 2.04 | 2.04 | 2.04 | 3.80 | 2.30 |
| | Li₂O | | 7.14 | 7.14 | 7.14 | 7.14 | 7.64 | 7.14 | 6.97 | 7.50 |
| | Na₂O | | | | | | | | 1.00 | |
| | K₂O | | 1.53 | 1.53 | 1.53 | 1.23 | 1.03 | 1.53 | 0.50 | 1.50 |
| | MgO | | 1.02 | 1.02 | 0.52 | 1.02 | 1.02 | 1.02 | 1.10 | 0.50 |
| | CaO | | 0.41 | 0.41 | 0.41 | 0.41 | 0.41 | | | |
| | SrO | | | | | | | | | |
| | BaO | | | | | | | | 1.25 | |
| | ZnO | | 2.88 | 1.88 | 3.38 | 2.88 | 2.88 | 2.88 | 4.60 | 3.50 |
| | ZrO₂ | | 5.60 | 5.60 | 5.60 | 5.60 | 5.60 | 6.01 | 5.60 | 5.50 |
| | Nb₂O₅ | | | | | | | | | |
| | Ta₂O₅ | | | | | | | | | |
| | TiO₂ | | | | | | | | | |
| | Sb₂O₃ | | 0.08 | 0.08 | 0.08 | 0.08 | 0.08 | 0.08 | 0.08 | 0.08 |
| | Total | | 100.00 | 100.00 | 100.00 | 100.00 | 100.00 | 100.00 | 100.00 | 100.00 |
| | SiO₂ + Li₂O + Al₂O₃ + B₂O₃ | | 86.44 | 87.44 | 86.44 | 86.74 | 86.94 | 86.44 | 82.07 | 86.62 |
| | SiO₂/(B₂O₃ + Li₂O) | | 7.10 | 6.40 | 7.10 | 7.10 | 6.73 | 7.10 | 6.02 | 7.52 |
| | Al₂O₃ + ZrO₂ | | 18.04 | 18.04 | 18.04 | 18.34 | 18.04 | 18.45 | 17.70 | 11.20 |
| Crystallization | Nucleation | Temperature [° C.] | 600 | 600 | 600 | 600 | 600 | 600 | 600 | 600 |
| Conditions | | Retention time [h] | 5 | 5 | 5 | 5 | 5 | 5 | 5 | 5 |
| | Crystal | Temperature [° C.] | 660 | 660 | 680 | 660 | 660 | 700 | 680 | 680 |
| | growth | Retention time [h] | 5 | 5 | 5 | 5 | 5 | 5 | 5 | 5 |

| | | | | | | | | |
|---|---|---|---|---|---|---|---|---|
| Tg [° C.] | 576 | 561 | 573 | 577 | 570 | 575 | 586 | — |

TABLE 3

| Examples | | | Ex. 17 | Ex. 18 | Ex. 19 | Ex. 20 | Ex. 21 | Ex. 22 | Ex. 23 | Ex. 24 |
|---|---|---|---|---|---|---|---|---|---|---|
| Composition | SiO₂ | | 67.20 | 65.68 | 64.20 | 65.86 | 64.86 | 66.36 | 64.86 | 65.81 |
| [mass %] | Al₂O₃ | | 5.60 | 9.44 | 10.10 | 6.24 | 12.74 | 12.74 | 10.74 | 10.72 |
| | B₂O₃ | | 1.15 | 7.00 | 1.50 | 4.00 | 3.00 | 2.00 | 2.00 | 2.00 |
| | P₂O₅ | | 2.60 | 2.04 | 4.85 | 2.25 | 2.04 | 2.54 | 2.04 | 2.14 |
| | Li₂O | | 5.97 | 7.14 | 6.97 | 8.14 | 7.14 | 7.14 | 7.14 | 7.13 |
| | Na₂O | | 2.00 | | | | | | | 0.50 |
| | K₂O | | 1.50 | 1.53 | 1.50 | 1.73 | | 2.23 | 1.23 | 0.73 |
| | MgO | | 2.20 | 0.41 | 1.10 | 1.02 | 2.02 | 1.02 | 1.02 | 1.02 |
| | CaO | | | | 1.00 | | 0.41 | 0.41 | 0.41 | 0.41 |
| | SrO | | | | | | | | | |
| | BaO | | | | | | | | | |
| | ZnO | | 5.10 | 1.08 | 3.10 | 2.88 | 3.11 | 2.88 | 1.88 | 2.88 |
| | ZrO₂ | | 5.60 | 5.60 | 5.00 | 7.60 | 4.60 | 2.30 | 8.68 | 5.60 |
| | Nb₂O₅ | | | | | | | | | 1.00 |
| | Ta₂O₅ | | | | | | | | | |
| | TiO₂ | | | | | | | | | |
| | Sb₂O₃ | | 1.08 | 0.08 | 0.68 | 0.28 | 0.08 | 0.38 | | 0.06 |
| | Total | | 100.00 | 100.00 | 100.00 | 100.00 | 100.00 | 100.00 | 100.00 | 100.00 |
| | SiO₂ + Li₂O + Al₂O₃ + B₂O₃ | | 79.92 | 89.26 | 82.77 | 84.24 | 87.74 | 88.24 | 84.74 | 85.66 |
| | SiO₂/(B₂O₃ + Li₂O) | | 9.44 | 4.64 | 7.58 | 5.43 | 6.40 | 7.26 | 7.10 | 7.21 |
| | Al₂O₃ + ZrO₂ | | 11.20 | 15.04 | 15.10 | 13.84 | 17.34 | 15.04 | 19.42 | 16.32 |
| Crystallization | Nucleation | Temperature [° C.] | 600 | 600 | 600 | 600 | 600 | 600 | 600 | 600 |
| Conditions | | Retention time [h] | 5 | 5 | 5 | 5 | 5 | 5 | 5 | 5 |
| | Crystal | Temperature [° C.] | 670 | 640 | 670 | 640 | 640 | 660 | 680 | 660 |
| | growth | Retention time [h] | 5 | 5 | 5 | 5 | 5 | 5 | 5 | 5 |

| | | | | | | | | |
|---|---|---|---|---|---|---|---|---|
| Tg [° C.] | 574 | 536 | 580 | 545 | 541 | 569 | 531 | 572 |

TABLE 4

| Examples | | | Ex. 25 | Ex. 26 | Ex. 27 | CEx. 1 |
|---|---|---|---|---|---|---|
| Composition | SiO₂ | | 65.81 | 64.80 | 64.86 | 75.50 |
| [mass %] | Al₂O₃ | | 10.72 | 12.72 | 8.44 | 7.60 |
| | B₂O₃ | | 2.00 | 2.00 | 3.00 | |
| | P₂O₅ | | 2.14 | 2.14 | 2.04 | 1.90 |
| | Li₂O | | 7.13 | 7.13 | 8.64 | 9.60 |
| | Na₂O | | 0.50 | 0.50 | 1.00 | |
| | K₂O | | 0.73 | 0.73 | 1.03 | 1.00 |
| | MgO | | 1.02 | 1.02 | 1.02 | 1.00 |
| | CaO | | | 0.41 | 0.41 | |
| | SrO | | | | | |
| | BaO | | | | 1.00 | |
| | ZnO | | 2.88 | 2.88 | 2.88 | 0.50 |
| | ZrO₂ | | 5.60 | 5.60 | 5.60 | 2.40 |
| | Nb₂O₅ | | | | | |
| | Ta₂O₅ | | 1.41 | | | |
| | TiO₂ | | | | | |
| | Sb₂O₃ | | 0.06 | 0.07 | 0.08 | 0.50 |
| | Total | | 100.00 | 100.00 | 100.00 | 100.00 |
| | SiO₂ + Li₂O + Al₂O₃ + B₂O₃ | | 85.66 | 86.65 | 84.94 | 92.70 |
| | SiO₂/(B₂O₃ + Li₂O) | | 7.21 | 7.10 | 5.57 | 7.86 |
| | Al₂O₃ + ZrO₂ | | 16.32 | 18.32 | 14.04 | 10.00 |
| Crystallization | Nucleation | Temperature [C.] | 600 | 600 | 600 | 560 |
| Conditions | | Retention time [h] | 5 | 5 | 5 | 10 |
| | Crystal | Temperature [C.] | 660 | 660 | 700 | 740 |
| | growth | Retention time [h] | 5 | 5 | 5 | 4 |

| | | | | |
|---|---|---|---|---|
| Tg [C] | 578 | 579 | 642 | — |

### 2. Evaluation of Inorganic Composition Article

As to the obtained chemically reinforced crystallized glass substrate, the following properties were measured, and a four-point bending strength test was conducted. The results are shown in Tables 5 to 9.

The photoelastic constant (β) was determined as follows: a shape of a sample was made to be a disk having a diameter of 25 mm and a thickness of 8 mm, by polishing opposing sides of the sample, a compressive load was applied to the disk in a predetermined direction, an optical path difference occurring in a center of the glass was measured, and the photoelastic constant was obtained by using the relational expression δ=β*d*F. In the relational expression, δ (nm) denotes the optical path difference, d (mm) denotes the glass thickness, and F (MPa) denotes the stress.

The compressive stress CS (MPa) of the compressive stress layer was measured by using a glass surface stress meter (“FSM-6000LE Series” manufactured by Orihara Manufacturing Co., Ltd.). For the measurement light source, a light source having a wavelength of 365 nm was used, and the value of the refractive index at the wavelength of 365 nm was calculated by using the quadratic approximate expression from the measured values of the refractive index at the wavelengths of the C-line, the d-line, the F-line, and the g-line according to the V-block method specified in JIS B 7071-2:2018.

The value of the photoelastic constant used in the measurement of CS was calculated by using a quadratic approximate expression from the measured values of the photoelastic constant at the wavelength of 435.8 nm, the wavelength of 546.1 nm, and the wavelength of 643.9 nm. The photoelastic constant of 31.3 was used. As the value of CS of Comparative Example 1-1, the value of Example 2 of Patent Document 2 was used.

A depth DOLzero (μm) and central tensile stress (CT) of the compressive stress layer when the compressive stress was 0 MPa, were measured by using a scattered photoelastic stress meter (“SLP-1000”, manufactured by Orihara Manufacturing Co., LTD.). As a measurement light source, a light source having a wavelength of 405 nm was used for Examples 1-1 to 1-9 and a light source having a wavelength of 518 nm was used for Examples 1-10 to 1-29.

The value of the refractive index at the wavelength of 405 nm or 518 nm was calculated by using a quadratic approximate expression from the measured values of the refractive index at the wavelengths of the C-line, the d-line, the F-line, and the g-line according to the V-block method specified in JIS B 7071-2:2018.

The “substrate thickness” shown in Tables 5 to 9 is the thickness (mm) of the chemically reinforced crystallized glass substrate, and the “CSxDOLzero/substrate thickness” shown in Tables 5 to 9 is the value obtained by multiplying the compressive stress CS (MPa) by a value that was obtained by dividing DOLzero (μm) by the thickness (mm) of the chemically reinforced crystallized glass substrate.

The photoelastic constant at the wavelength of 405 nm or 518 nm used in the measurements of DOLzero and CT can be calculated by using a quadratic approximate expression from the measured values of the photoelastic constant at the wavelength of 435.8 nm, the wavelength of 546.1 nm, and the wavelength of 643.9 nm. As the photoelastic constant, 31.0 was used in Examples 1-1 to 1-9, and 30.1 was used in Examples 1-10 to 1-29. As the photoelastic constant of Comparative Example 1-1, the value of Example 2 of Patent Document 2 was used.

### (2) Four-Point Bending Strength Test

For the crystallized glass substrate, a bending stress (MPa) was measured by conducting a four-point bending strength test using a bending measuring device (“TFM-01” manufactured by Tateno Machinery, Co., Ltd.), on the basis of JIS1601:2008 under the conditions that the distance between the external fulcrums of the support was 40 mm, the distance between the internal fulcrums was 20 mm, and the crosshead velocity was 10 mm/min. The results are shown in Tables 5 to 9.

TABLE 5

| | | Example 1-1 | Example 1-2 | Example 1-3 | Example 1-4 | Example 1-5 | Example 1-6 |
|---|---|---|---|---|---|---|---|
| Base material of Crystalized glass | | Example 1 | Example 1 | Example 1 | Example 1 | Example 1 | Example 1 |
| Substrate Thickness (mm) | | 0.50 | 0.68 | 0.50 | 0.68 | 0.60 | 0.60 |
| ※actual measument size | | | | | | | |
| Reinforcing | 1st Stage | KNO₃ | KNO₃ | KNO₃ | KNO₃ | KNO₃ | KNO₃ |
| Conditions | | 10:NaNO₃ 1 | 10:NaNO₃ 1 | 8:NaNO₃ 1 | 8:NaNO₃ 1 | 10:NaNO₃ 1 | 8:NaNO₃ 1 |
| | | 450° C. × | 450° C. × | 450° C. × | 450° C. × | 450° C. × | 450° C. × |
| | | 120 min | 163 min | 300 min | 300 min | 300 min | 300 min |
| | 2nd Stage | KNO₃ | KNO₃ | — | — | — | — |
| | | 400° C. × | 400° C. × | — | — | — | — |
| | | 300 min | 300 min | | | | |

| | | | | | | |
|---|---|---|---|---|---|---|
| CS (MPa) | 1028 | 1034 | 596 | 642 | 625 | 602 |
| DOLzero (μm) | 115 | 151 | 114 | 151 | 127 | 125 |
| CS × DOLzero/Substrate Thickness | 237 | 230 | 136 | 143 | 132 | 126 |
| Bending Stress (MPa) | 1113 | 1242 | 819 | 908 | 942 | 963 |

TABLE 6

| | | Example 1-7 | Example 1-8 | Example 1-9 | Example 1-10 | Example 1-11 | Example 1-12 |
|---|---|---|---|---|---|---|---|
| Base material of Crystalized glass | | Example 1 | Example 1 | Example 1 | Example 1 | Example 1 | Example 1 |
| Substrate Thickness (mm) | | 0.60 | 0.60 | 0.60 | 0.50 | 0.60 | 0.50 |
| ※actual measument size | | | | | | | |
| Reinforcing | 1st Stage | KNO₃ | KNO₃ | KNO₃ | KNO₃ | KNO₃ | KNO₃ |
| Conditions | | 10:NaNO₃ 1 | 10:NaNO₃ 1 | 5:NaNO₃ 1 | 10:NaNO₃ 1 | 10:NaNO₃ 1 | 8:NaNO₃ 1 |
| | | 450° C. × | 450° C. × | 450° C. × | 450° C. × | 450° C. × | 450° C. × |
| | | 144 min | 144 min | 144 min | 120 min | 144 min | 300 min |
| | 2nd Stage | KNO₃ | KNO₃ | KNO₃ | KNO₃ | KNO₃ | — |
| | | | 50:NaNO₃ 1 | 50:NaNO₃ 1 | 50:NaNO₃ 1 | 50:NaNO₃ 1 | |
| | | 400° C. × | 400° C. × | 400° C. × | 400° C. × | 400° C. × | — |
| | | 300 min | 300 min | 300 min | 300 min | 300 min | |

| | | | | | | |
|---|---|---|---|---|---|---|
| CS (MPa) | 1051 | 818 | 827 | 868 | 886 | 620 |
| DOLzero (μm) | 127 | 125 | 129 | 110 | 130 | 110 |
| CS × DOLzero/Substrate Thickness | 222 | 170 | 177 | 190 | 191 | 136 |
| Bending Stress (MPa) | 1191 | 1091 | 1113 | 964 | 1039 | 917 |

TABLE 7

| | | Example 1-13 | Example 1-14 | Example 1-15 | Example 1-16 | Example 1-17 | Example 1-18 |
|---|---|---|---|---|---|---|---|
| Base material of Crystalized glass | | Example 1 | Example 1 | Example 1 | Example 1 | Example 1 | Example 1 |
| Substrate Thickness (mm) | | 0.60 | 0.50 | 0.50 | 0.60 | 0.60 | 0.53 |
| ※actual measument size | | | | | | | |
| Reinforcing | 1st Stage | KNO₃ | NaNO₃ | NaNO₃ | NaNO₃ | NaNO₃ | NaNO₃ |
| Conditions | | 8:NaNO₃ 1 | | | | | |
| | | 450° C. × | 450° C. × | 450° C. × | 450° C. × | 450° C. × | 450° C. × |
| | | 300 min | 60 min | 120 min | 60 min | 120 min | 80 min |
| | 2nd Stage | — | KNO₃ | KNO₃ | KNO₃ | KNO₃ | KNO₃ |
| | | | 50:NaNO₃ 1 | 50:NaNO₃ 1 | 50:NaNO₃ 1 | 50:NaNO₃ 1 | |
| | | — | 400° C. × | 400° C. × | 400° C. × | 400° C. × | 400° C. × |
| | | | 300 min | 300 min | 300 min | 300 min | 300 min |

| | | | | | | |
|---|---|---|---|---|---|---|
| CS (MPa) | 649 | 887 | 869 | 913 | 898 | 1121 |
| DOLzero (μm) | 127 | 107 | 108 | 117 | 128 | 113 |
| CS × DOLzero/Substrate Thickness | 137 | 189 | 187 | 178 | 192 | 239 |
| Bending Stress (MPa) | 907 | 1254 | 1062 | 981 | 995 | 1006 |

TABLE 8

| | | Example 1-19 | Example 1-20 | Example 1-21 | Example 1-22 | Example 1-23 | Example 1-24 |
|---|---|---|---|---|---|---|---|
| Base material of Crystalized glass | | Example 1 | Example 1 | Example 1 | Example 1 | Example 1 | Example 1 |
| Substrate Thickness (mm) | | 0.63 | 0.53 | 0.63 | 0.53 | 0.63 | 0.57 |
| ※actual measument size | | | | | | | |
| Reinforcing | 1st Stage | NaNO₃ | NaNO₃ | NaNO₃ | KNO₃ | KNO₃ | NaNO₃ |
| Conditions | | | | | 10:NaNO₃ 1 | 10:NaNO₃ 1 | |
| | | 450° C. × | 450° C. × | 450° C. × | 450° C. × | 450° C. × | 380° C. × |
| | | 80 min | 80 min | 80 min | 120 min | 120 min | 60 min |
| | 2nd Stage | KNO₃ | KNO₃ | KNO₃ | KNO₃ | KNO₃ | KNO₃ |
| | | | 50:NaNO₃ 1 | 50:NaNO₃ 1 | | | 40:NaNO₃ 1 |
| | | 400° C. × | 400° C. × | 400° C. × | 400° C. × | 400° C. × | 400° C. × |
| | | 300 min | 300 min | 300 min | 300 min | 300 min | 240 min |

| | | | | | | |
|---|---|---|---|---|---|---|
| CS (MPa) | 1134 | 909 | 927 | 1166 | 1184 | 865 |
| DOLzero (μm) | 135 | 115 | 13 | 110 | 131 | 116 |
| CS × DOLzero/Substrate Thickness | 242 | 196 | 193 | 243 | 245 | 176 |
| Bending Stress (MPa) | 1070 | 962 | 1053 | 943 | 1092 | 1011 |

TABLE 9

| | | Example 1-25 | Example 1-26 | Example 1-27 | Example 1-28 | Example 1-29 | Comp. Ex. 1-1 |
|---|---|---|---|---|---|---|---|
| Base material of Crystalized glass | | Example 1 | Example 1 | Example 1 | Example 1 | Example 1 | Comp. Ex. 1 |
| Substrate Thickness (mm) | | 0.57 | 0.57 | 0.57 | 0.57 | 0.57 | 0.55 |
| ※actual measument size | | | | | | | |
| Reinforcing | 1st Stage | NaNO₃ | NaNO₃ | NaNO₃ | NaNO₃ | NaNO₃ | NaNO₃ |
| Conditions | | 380° C. × | 380° C. × | 380° C. × | 380° C. × | 380° C. × | 450° C. × |
| | | 60 min | 100 min | 60 min | 100 min | 100 min | 480 min |
| | 2nd Stage | KNO₃ | KNO₃ | KNO₃ | KNO₃ | KNO₃ | — |
| | | 70:NaNO₃ | 70:NaNO₃ | 50:NaNO₃ | 50:NaNO₃ | 50:NaNO₃ | |
| | | 1:LiNO₃ 0.05 | 1:LiNO₃ 0.05 | 1:LiNO₃ 0.05 | 1:LiNO₃ 0.05 | 1:LiNO₃ 0.05 | |
| | | 400° C. × | 400° C. × | 400° C. × | 400° C. × | 400° C. × | — |
| | | 300 min | 300 min | 300 min | 300 min | 420 min | |

| | | | | | | |
|---|---|---|---|---|---|---|
| CS (MPa) | 817 | 818 | 772 | 778 | 773 | 380 |
| DOLzero (μm) | 103 | 107 | 103 | 106 | 117 | 85 |
| CS × DOLzero/Substrate Thickness | 148 | 153 | 140 | 145 | 159 | 59 |
| Bending Stress (MPa) | 1031 | 1058 | 1088 | 998 | 889 | 407 |

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1. An inorganic composition article comprising reinforced crystallized glass, wherein
the crystallized glass comprises one or more selected from α-cristobalite and α-cristobalite solid solution as a main crystal phase, and
the crystallized glass has, by mass % in terms of oxide,
a content of a SiO₂ component being 50.0% to 75.0%,
a content of a Li₂O component being 3.0% to 10.0%,
a content of an Al₂O₃ component being 5.0% or more and less than 15.0%,
a content of a B₂O₃ component being more than 0% and 10.0% or less,
a content of a P₂O₅ component being more than 0% and 10.0% or less, and
a mass proportion of SiO₂/(B₂O₃+Li₂O) being 3.0 to 10.0, and
wherein the inorganic composition article has a compressive stress layer on a surface, and
the inorganic composition article has a four-point bending strength of 760 MPa or higher.

2. The inorganic composition article according to claim 1,
wherein the crystallized glass has, by mass % in terms of oxide,
a content of a ZrO₂ component being more than 0% and 10.0% or less, and
a total content of the Al₂O₃ component and the ZrO₂ component being 10.0% or more.

3. The inorganic composition article according to claim 1, wherein
the crystallized glass has, by mass % in terms of oxide,
a content of a K₂O component being 0% to 5.0%.

4. The inorganic composition article according to claim 1,
wherein the crystallized glass has, by mass % in terms of oxide,
a content of a Na₂O component being 0% to 4.0%,
a content of a MgO component being 0% to 4.0%,
a content of a CaO component being 0% to 4.0%,
a content of a SrO component being 0% to 4.0%,
a content of a BaO component being 0% to 5.0%,
a content of a ZnO component being 0% to 10.0%, and
a content of a Sb₂O₃ component being 0% to 3.0%.

5. The inorganic composition article according to claim 1,
wherein the crystallized glass has, by mass % in terms of oxide,
a content of a Nb₂O₅ component being 0% to 5.0%,
a content of a Ta₂O₅ component being 0% to 6.0%, and
a content of a TiO₂ component being 0% or more and less than 1.0%.

6. The inorganic composition article according to claim 1, wherein a glass transition temperature Tg of glass before crystallization of the crystallized glass is 610° C. or lower.

7. The inorganic composition article according to claim 1, wherein [compressive stress CS (MPa)]×[thickness of the compressive stress layer DOLzero (μm)]/[substrate thickness t (mm)] is 100 to 350.
